(19) United States
(12) Patent Application Publication
(10) Pub. No.: US 2019/0198212 A1
(43) Pub. Date: Jun. 27, 2019

(54) PERSONAL ELECTRONIC DEVICE CASE AND MOUNTING SYSTEM

(71) Applicant: Marc Levy, Kirkland, WA (US)

(72) Inventor: Marc Levy, Kirkland, WA (US)

(21) Appl. No.: 16/227,663

(22) Filed: Dec. 20, 2018

Related U.S. Application Data
(60) Provisional application No. 62/610,002, filed on Dec. 22, 2017.

(51) Int. Cl. H01F 7/02; H02J 7/02; H02J 7/00; H02J 50/10; F16M 11/22; F16M 13/02; F16M 11/28; F16M 11/20; F16M 13/04

(52) U.S. Cl. CPC H01F 7/02; H02J 7/025; H02J 7/0044; H02J 50/10; F16M 11/22; F16M 2200/068; F16M 11/28; F16M 11/2021; F16M 13/04; F16M 2200/00; F16M 13/022

(57) ABSTRACT

The present technology relates generally to a personal electronic device case and mounting system. A case for a personal electronic device includes a recess in the back surface of the case and is configured to receive a protrusion on a corresponding mount within the recess. Magnets arranged around the recess are configured to magnetically couple to magnets arranged around the protrusion to aid in securely coupling the case to the mount. The size and shape of the recess and protrusion and the arrangement of magnets allows the case to securely couple to the mount in a plurality of orientations. The recess is positioned over wireless charging circuitry in the device such that wirelessly charging the device is possible when the case is securely coupled to a mount that incorporates a wireless charging pad.

### CROSS-REFERENCE TO RELATED APPLICATIONS

This non-provisional patent application claims the benefit of and priority to U.S. Provisional Patent Application No. 62/610,002, titled “PERSONAL ELECTRONIC DEVICE CASE AND MOUNTING SYSTEM” and filed Dec. 22, 2017, which is incorporated herein in its entirety by reference thereto.

### TECHNICAL FIELD

The present technology relates generally to personal electronic device cases and mounting systems.

### BACKGROUND

Smart phones, tablets, and other portable electronic devices are common pieces of technology used by many. Typically, using the portable electronic device (PED) requires that a person devote at least one of their hands to holding and manipulating the device, which may inhibit the person's ability to perform other functions while using the device. As an example, people use the modern PED while working at a desk, studying, exercising, moving from place to place, etc. The PEDs often include telephone functionality and/or navigation software designed to help users navigate to a desired destination. Many people often use the PED while operating a vehicle. Many state laws only allow hands-free use of the PED while operating a vehicle to help ensure that the operator's attention remains focused on the task of operating the vehicle. In another example, a person wishing to view the screen of their PED while using a personal computer may be unable to securely arrange the device such that the screen remains constantly visible without the person having to move their hands away from the personal computer to re-orient the device.

Many modern PEDs include inductive wireless charging circuitry positioned in the device and adjacent to the rear surface of the device. When the device is placed on a wireless charging pad, current flowing through the charging pad interacts with wireless charging circuitry to charge the device's battery. The wireless charging circuitry must be arranged in close proximity to the charging pad area near the conductive coil and the space between the PED and charging pad must be free of conductive material for proper and efficient conductive charging.

Various conventional mounting accessories have been developed to aid in the hands-free use of PEDs. Some of these mounting accessories utilize clamping mechanisms to hold onto the edges of the personal electronic device. Other mounting accessories incorporate specialized cases for the device that mate with a mounting apparatus, relying on expensive, finely machined features and surfaces to ensure that the case and mounting apparatus remain securely fastened to each other. However, these mounting accessories are often not easy to use, and they sometimes require both hands to securely attach the device to the mounting accessory. Furthermore, the mounting accessories are typically only usable for a single situation. For example, a mounting accessory used to enable the hands-free use of a device while a person operates a vehicle may not be also used to enable the hands-free use of the device while the person rides a bicycle or sits at a desk. Moreover, mounting accessories that incorporate cases for the personal electronic device are often too thick or include conductive materials which impede/block the wireless charging circuitry, preventing the device from being wirelessly charged while coupled to the mounting accessory.

### BRIEF DESCRIPTION OF THE DRAWINGS

FIG. 1A is an isometric view of a PED received within a case and a mounting structure configured in accordance with one or more embodiments of the present technology.

FIG. 1B is a front elevation view of the case of FIG. 1A with the PED removed from the case.

FIG. 2A is an isometric view of a mounting structure having a wireless charging pad configured in accordance with embodiments of the present technology.

FIG. 2B is a top cut-away view of the wireless charging pad of FIG. 2A, in accordance with embodiments of the present technology.

FIG. 3 is an isometric view of a vehicle mount having a wireless charging pad configured in accordance with embodiments of the present technology.

FIG. 4A is an isometric view of an arm mount configured in accordance with embodiments of the present technology.

FIG. 4B is a partially exploded top isometric view of the arm mount of FIG. 4A.

FIG. 4C is a partially exploded bottom isometric view of the arm mount of FIG. 4A.

FIG. 5A is top plan view of a handlebar mount configured in accordance with embodiments of the present technology.

FIG. 5B is a side elevation view of the handlebar mount of FIG. 5A.

FIG. 5C is a partially exploded isometric view of the bicycle handlebar mount of FIG. 5A.

FIG. 6A is a front elevation view of a clip mount configured in accordance with embodiments of the present technology.

FIG. 6B is an isometric view of the clip mount of FIG. 6A.

FIG. 7A is a top plan view of a strap mount configured in accordance with embodiments of the present technology.

FIG. 7B is an isometric view of the strap mount of FIG. 7A.

FIG. 8A is a front elevation view of a PED case having arrays of magnets configured in accordance with embodiments of the present technology.

FIG. 8B is an enlarged isometric view of a portion of the case of FIG. 8A.

FIG. 9A is a front elevation view of a PED case having arrays of magnets configured in accordance with embodiments of the present technology.

FIG. 9B is an enlarged isometric view of a portion of the case of FIG. 9A.

FIG. 10A is an isometric view of a mount that includes a clamping mechanism configured in accordance with embodiments of the present technology.

FIG. 10B is an isometric view of a case received within the mount of FIG. 10A.

FIG. 11 is an isometric view of an interface plate configured in accordance with embodiments of the present technology.

FIG. 12A is a top plan view of an interface plate configured in accordance with an embodiment of the present technology.

FIG. 12B is a top plan view of an interface plate configured in accordance with another embodiment of the present technology.

FIG. 12C is a top plan view of an interface plate configured in accordance with another embodiment of the present technology.

FIG. 12D is a top plan view of an interface plate configured in accordance with another embodiment of the present technology.

### DETAILED DESCRIPTION

The present technology is directed to a personal electronic device (PED) case and mounting system and associated systems and methods. Several embodiments of the present technology are related to PED cases having magnets configured to couple to magnets on a mounting apparatus and having an opening configured to mate with a protrusion on the mounting apparatus. One aspect of the present technology provides a mounting assembly for a personal electronic device, comprising a case having a back wall and sidewalls connected to the backwall to define an interior area configured to receive the personal electronic device. The back wall has opposing front and rear surfaces, with the front surface facing toward the interior area and being configured to be positioned adjacent to the personal electronic device when the personal electronic device is received within the interior area. A recess is formed in the rear surface. The recess has a central portion and a plurality of registration recesses spaced radially apart from each other. A case magnet is positioned adjacent to the recess and spaced apart from the central portion. A mounting structure is releasably engageable with the case at a selected radial orientation. The mounting structure comprises a receiving surface configured to be positioned adjacent to the rear surface when the case is engaged with the mounting structure. A protrusion extends away from the receiving surface and is configured to be securely received in the recess when the case is coupled to the mounting structure. The protrusion has a central protuberance that fits closely in the central portion of the recess, and one or more radial registration protuberances is positioned to fit in selected registration recess to control a selected radial orientation of the case relative to the mounting structure. A mount magnet is positioned adjacent to the protrusion and is arranged to align with the case magnet when the case is coupled to the mounting structure in the selected radial orientation. The case is mechanically and magnetically restricted from rotating when the case is engaged with the mounting structure.

Another aspect of the technology provides a mounting assembly for a personal electronic device. The mounting assembly has a case configured to securely receive the personal electronic device. The case comprises a recess formed in a rear surface of the case, a first plurality of case magnets arranged to form a first array positioned adjacent to the recess such that each of the first plurality of case magnets does not overlap with the recess. A second plurality of case magnets is arranged to form a second array, wherein the second array is positioned adjacent to the recess such that each of the second plurality of case magnets does not overlap with the recess. A mounting structure is releasably couplable to the case with the case in a selected orientation. The mounting structure has a protrusion extending away from a receiving surface and configured to closely fit in the recess when the case is coupled to the mounting structure. A first plurality of mount magnets arranged to form a third array is positioned adjacent to the protrusion such that each of the first plurality of mount magnets does not overlap with the protrusion. A second plurality of mount magnets is arranged to form a fourth array positioned adjacent to the protrusion such that each of the second plurality of mount magnets does not overlap with the protrusion. When the case is coupled to the mounting structure in the selected orientation, selected first case magnets are positioned over and magnetically coupled to the selected mount magnets, and selected second case magnets are positioned over and magnetically coupled to selected mount magnets.

Another aspect of the technology provides a mounting assembly for a personal electronic device. The mounting assembly has a case with an interior area configured to receive the personal electronic device. The case has a recess formed therein with a central portion and a plurality of registration recesses spaced apart from each other. A case magnet is positioned adjacent to the recess and spaced apart from the central portion. A mounting structure is releasably engageable with the case at a selected orientation. The mounting structure has a protrusion configured to be securely received in the recess when the case is engaged with the mounting structure. The protrusion has a central protuberance that fits closely in the central portion of the recess. One or more registration protuberances is adjacent to the central protuberance and is positioned to fit in selected ones of the registration recesses to control a selected orientation of the case relative to the mounting structure. A mount magnet is positioned adjacent to the protrusion and is arranged to align with the case magnet when the case is engaged with the mounting structure in the selected orientation. The case is mechanically and magnetically restricted from rotating when the case is engaged with the mounting structure.

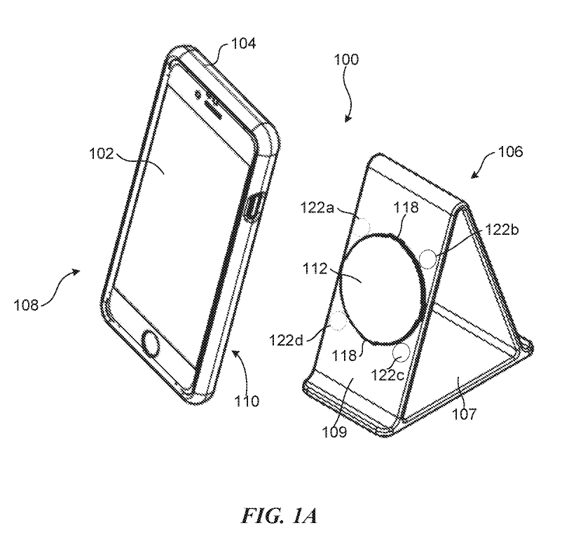

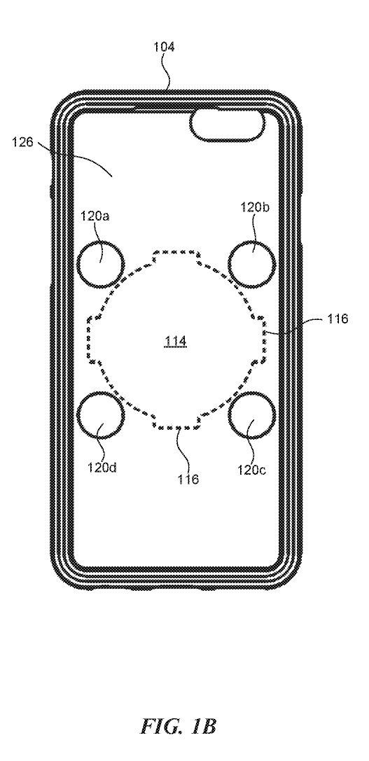

Specific details of several embodiments of the present technology are described herein with reference to FIGS. 1A-12D. Although many of the embodiments are described with respect to devices, systems, and methods for mounting a personal electronic device, it should be noted that other applications and embodiments in addition to those disclosed herein are within the scope of the present technology. Further, embodiments of the present technology can have different configurations, components, and/or procedures than those shown or described herein. Moreover, a person of ordinary skill in the art will understand that embodiments of the present technology can have configurations, components, and/or procedures in addition to those shown or described herein and that these and other embodiments can be without several of the configurations, components, and/or procedures shown or described herein without deviating from the present technology.

FIGS. 1A and 1B illustrate a mounting system 100 in accordance with an embodiment of the present technology. The mounting system 100 has a case 104 that receives a personal electronic device 102 (also referred to as a “device”) and a mounting apparatus 106 (also referred to as a “mount”) configured to be securely and releasably coupled to the case 104 (FIG. 1A) illustrating the features on the rear surface 110 of the case 104. The device 102 is received within the case 104 such that a front surface 108 of the device 102 remains exposed while the edges and rear surface of the device 102 are enclosed within the case 104. The mount 106 may be a desk (or table) mounting apparatus having a base portion 107 configured to be placed against a flat surface (e.g., a desk or a table) and having a receiving surface 109 on which the case 104 is received.

To ensure that the case 104 remains properly oriented relative to the mount 106 and is restrained from moving when the case 104 is coupled to the mount 106, the mount 106 and the case 104 include mating alignment features. For example, the mount 106 includes a shaped protrusion 112 formed on the receiving surface 109 (FIG. 1A), and the case 104 includes a similarly shaped recess 114 (FIG. 1B). The protrusion 112 extends away from the receiving surface 109 of the mount 106, and the mating recess 114 is formed in the rear surface 110 of the case 104. The recess 114 is configured to receive the protrusion 112 when the case 104 and the mount 106 are securely mated to each other. The recess 114 and protrusion 112 are sized and shaped such that the protrusion 112 fits snugly within the recess 114, thereby limiting any translational movement of the case 104 relative to the mount 106.

In the illustrated embodiment, the protrusion 112 has a generally circular shape and a plurality of alignment and anti-rotation tabs 118 spaced around the perimeter of the protrusion 112. Similarly, the recess 114 has a generally circular shape and a plurality of cut-outs 116 (FIG. 1B) spaced around the perimeter of the recess 114 so as to receive the tabs of the protrusion 112 when the protrusion 112 is mated in the recess 114. The size, number, and position of the tabs 118 and cut-outs 116 are such that, when the case 104 is removably engaged with the mount 106, the protrusion 112 is securely received within the recess 114, and each of the tabs 118 is positioned within a given one of the cut-outs 116. Arranging the tabs 118 within the cut-outs 116 limits the ability of the protrusion 112 to rotate within the recess 114, thereby restricting the undesired rotation of the case 104 relative to the mount 106.

The case 104 also includes a plurality of case magnets 120a-d disposed in the inner surface 126 and arranged adjacent to and radially outward of the recess 114. Similarly, the mount 106 includes a plurality of mount magnets 122a-d disposed in the receiving surface 109 and arranged adjacent to and radially outward of the protrusion 112. In the illustrated embodiment, four case magnets 120a-d are positioned such that, when the case 104 is coupled to the mount 106, each of the four case magnets 120a-d is adjacent to one of the corresponding one of the four mount magnets 122a-d. Although the illustrated embodiment has four case magnets 120a-d and four corresponding mount magnets 122a-d, other embodiments can have different numbers of mating magnets. In addition, the number of case magnets 120 can be different than the number of mount magnets 122.

The illustrated case magnets 120a-d are disk-shaped permanent magnets having fixed north and south poles, where all four of the case magnets 120a-d are oriented such that their north poles are aligned along a common direction relative to the inner surface 126. Similarly, the mount magnets 122a-d are disk-shaped permanent magnets having fixed single north poles and fixed south poles, where all four of the mount magnets 122a-d are oriented such that their north poles are aligned along a common direction relative to the receiving surface 109. When the case 104 is securely positioned onto the mount 106 with the protrusion positioned in the recess 114, the case magnets 120a-d and the mount magnets 122a-d are oriented such that each of the case magnets 120a-d is magnetically coupled to a corresponding one of the mount magnet 122a-d with alignment of the respective north and south poles, such that the protrusion 112 is securely and magnetically retained in the recess 114 with the case 104 in the selected orientation relative to the mount 106. Because of this arrangement, the case magnets 120a-d and mount magnets 122a-d act together to provide a compressive force between the case 104 and the mount 106. Additionally, when the user brings the case 104 near the mount 106, the magnets prevent the case 104 but being partially or improperly engaged in the mount 106 and in fact guide the components together for quick and easy attachment and retention in the correct position and orientation.

In some embodiments, all four of the case magnets 120a-d are oriented such that the south poles face away from the device 102 while all four of the mount magnets 122a-d are oriented such that their south poles face away from the receiving surface 109 (i.e., toward the case 104 when the case 104 is coupled to the mount 106). Because each of the case magnets 120a-d is arranged directly over a given one of the mount magnets 122a-d and because the south poles of a case magnet 120a-d are magnetically attracted to the north poles of a mount magnet 122a-d, each of the case magnets 120a-d magnetically couple to a corresponding mount magnet 122a-d. In other embodiments, however, all four of the case magnets 120a-d can be oriented such that their north poles are all directed away from the device 102 while all four of the mount magnets 122a-d are oriented such that their south poles are directed away from the receiving surface 109. Because the north pole of a case magnet 120 is magnetically attracted to the south pole of a mount magnet 122a-d, each of the case magnets 120 magnetically couple to a corresponding mount magnet 122a-d.

In the illustrated embodiment, the four cut-outs 116 and the four case magnets 120a-d are symmetrically arranged around a central point of the recess 114. Similarly, the four mount magnets 122a-d and the four tabs 118 are symmetrically arranged around a central point of the protrusion 112 such that the case 104 can be releasably retained on the mount 106 in four different orientations. Furthermore, because each of the case magnets 120a-d have north poles facing a common direction and each of the mount magnets 122a-d have south poles facing an opposite direction, each of the case magnets 120a-d is magnetically couplable to a respective one of the mount magnets 122a-d over which it is arranged when the case 104 is coupled to the mount 106 in any of the four different mounted orientations. In other words, the magnetic orientations of the case magnets 120a-d and the mount magnets 122a-d, along with the positions of the magnets 120a-d and 122a-d and the positions of the tabs 118 and cut-outs 116, ensure that the case 106 remains securely coupled to the mount 106 when the case 104 and mount 106 are in any of the four different mounted orientations. In the illustrated embodiment, the mounted orientation of the case corresponds to a ±90° rotation from the next rotational position. These mounted orientations can correspond to portrait or landscape orientations of the device 102 relative to the mount 106 and/or the structure on which the mount 106 is supported.

For example, if the user desires for the device 102 to operate in a portrait mode, the case 104 is coupled to the mount 106 such that the top edge of the case 104 is facing upward. In this configuration, the case magnet 120a is aligned with and magnetically coupled to the mount magnet 122a, the case magnet 120b is aligned with and magnetically coupled to the mount magnet 122b, the case magnet 120c is aligned with and magnetically coupled to the mount magnet 122c, and the case magnet 120a is aligned with and magnetically coupled to the mount magnet 122d. If the user desires to switch the orientation of the device so it operates in a landscape mode, the user may switch the orientation of the device by separating the case 104 from the mount 106, rotating the case 104 by 90° and inserting the protrusion 112 into the recess 114, thereby switching the rotational orientation of the device 102. In this landscape arrangement, the case magnet 120a is aligned with and magnetically coupled to the mount magnet 122b, the case magnet 120b is aligned with and magnetically coupled to the mount magnet 122c, the case magnet 120c is aligned with and magnetically coupled to the mount magnet 122d, and the case magnet 120d is aligned with and magnetically coupled to the mount magnet 122a. Alternatively, the case 102 can be positioned in an inverted landscape position with case magnets 120a, 120b, 120c, and 120d aligned with mount magnets 122d, 122a, 122b, 122c, respectively. The case 102 can also be positioned in an inverted portrait position with case magnets 120a, 120b, 120c, and 120d aligned with mount magnets 122c, 122d, 122a, and 122b, respectively.

As described above, the case 104 of the illustrated embodiment may be couplable to the mount 106 in four different orientations. In other embodiments, however, the case 104 may be couplable to the mount 106 in a different number of configurations. For example, in some embodiments, the case 104 may be couplable to the mount 106 in any desired number of orientations. In these other embodiments, the recess may include any desired number of cut-outs and case magnets while the protrusion may include any desired number of tabs and mount magnets to ensure that the case is couplable to the mount in the desired number of orientations. In the illustrated embodiment, the tabs 118 on the protrusion 112 extend radially outward, and the cutouts 116 on the recess 114 extend radially outward. In other embodiments, the tabs 118 and cut outs 116 may extend radially inward, although such a configuration would decrease the area within the recess 114, which may impact space available to accommodate wireless charging features, as discussed in greater detail below.

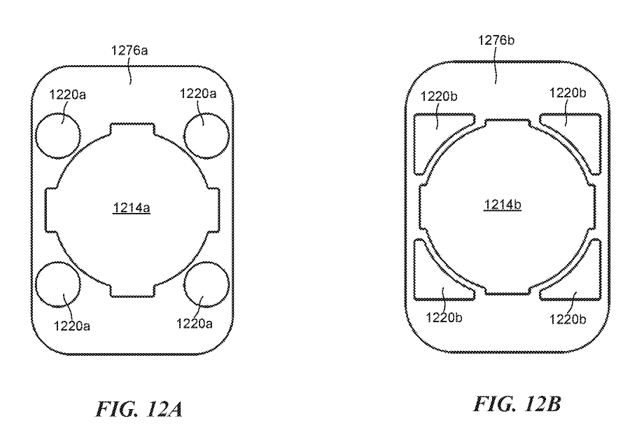

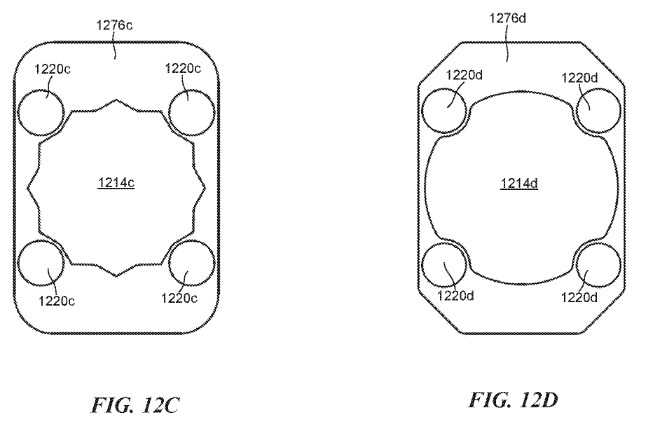

In the embodiments shown in FIGS. 1A-B, the case and mount magnets are disk-shaped magnets. In other embodiments, however, the case magnets and mount magnets may have different shapes. For example, in some embodiments, the case and mount magnets have a generally triangular shape (see FIG. 12B). Triangle-shaped magnets can better conform to the outer edges of the protrusion 112 and recess 114, allowing for a larger recess and protrusion relative to the mount 106 and case 104, respectively (i.e., larger diameter or area). Increasing the size of the recess and protrusion can help ensure that the wireless charging capabilities of the device are not inhibited by the case.

In the embodiment shown in FIG. 1B, the recess 114 extends completely through the rear surface 110 of the case 104 so that the rear surface of the device 102 is exposed and accessible via the recess 114. As a result, when the case 104 is mounted onto the mount 106 and the protrusion 112 is received within the recess 114, the surface of the protrusion 112 is immediately adjacent to or in direct contact with the rear surface of the device 102. In other embodiments, however, the recess 114 does not extend all the way through the rear surface 110 of the case 104. In these embodiments, the portion of the rear surface of the device 102 adjacent to the recess 114 remains covered and protected by a thin layer of the case material (e.g., plastic). As a result, when the case 104 is coupled to the mount 106 and the protrusion 112 is received within the recess 114, a thin layer of the case material remains interposed between the protrusion 112 and the rear surface of the device 102. The thin layer, however, is configured to minimize any substantive interference with wireless charging of the device 102.

To facilitate wireless charging, many modern devices 102 include a wireless charging receiver within and positioned adjacent to the rear surface of the device 102. When the device 102 is placed on a wireless charging pad, current flowing through an inductive coil in the pad interacts with the wireless charging receiver in the device, causing current to flow within the receiver, thereby charging the device's battery. However, if the distance between the wireless charging receiver and the wireless charging pad is too large, or if conductive material (e.g., metal) is located between the wireless charging receiver and the wireless charging pad, wireless charging of the device may be prevented or inhibited. In addition, if the wireless charging receiver and the wireless charging pad are positioned relative to each other so that the respective coils are misaligned, the result is a less efficient power transfer to the PED's battery. The case 104 and mount 106 configuration of the illustrated embodiments helps insure proper alignment easily and quickly every time so as to reliably provide efficient power transfer to the PED.

The wireless charging receiver is typically formed from a conductive coil arranged in the center of the rear surface of the device 102. To ensure that the case 104 does not limit the wireless charging capabilities of the device 102, the recess 114 is configured to be positioned directly over the conductive coil. Similarly, the case magnets 120a-d are configured to be positioned away from the wireless charging circuitry so as not to interfere with the conductive coil. In embodiments where the recess 114 extends completely through the rear surface 110, the rear surface of the device 102 is exposed, allowing a wireless charging pad received within the recess 114 to be placed in direct contact with the rear surface of the device, thereby enabling wireless charging of the device 102. In embodiments where the recess 114 does not extend completely through the rear surface 110, the remaining layer of case material that covers the rear surface of the device 102 is sufficiently thin so a wireless charging pad received within the recess 114 is close enough to the conductive coil that wireless charging through the remaining layer is enabled.

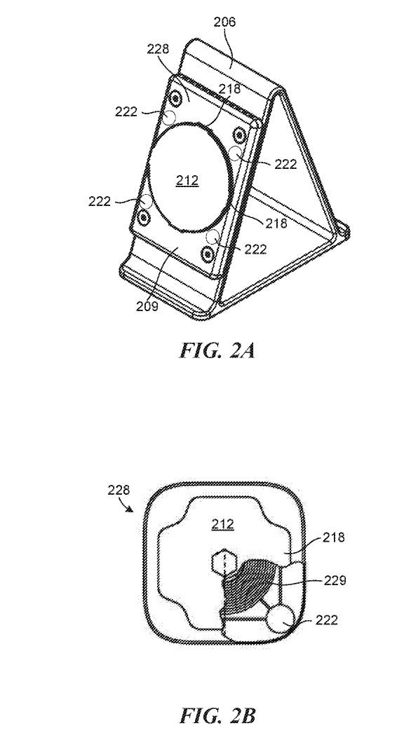

To allow the device 102 to be wirelessly charged while the case is coupled to the mount, the mount may incorporate a wireless charging pad. FIG. 2A is an isometric view of a mount 206 that includes a wireless charging pad 228 coupled to the receiving surface 209 of the mount 206 and FIG. 2B is a top cut-away view of the wireless charging pad 228. The wireless charging pad 228 includes a coil 229 configured to receive a current from a power source coupled to the wireless charging pad 228. The coil 229 is positioned within the protrusion 212 such that it is closely adjacent to the surface of the protrusion 212. In this way, the current from the coil 229 can pass through the protrusion 212, thereby enabling the wireless charging of a device coupled to the mount 206 due to the proximity of the wireless charging receiver in the device and the coil 229 when the protrusion 212 is received within the recess of the case. The mount 206 also includes a plurality of mount magnets 222 positioned around the protrusion 212 and the coil 229 such that the mount magnets 222 are configured to magnetically couple to case magnets (e.g., case magnets 120a-d FIG. 1B) when the case is coupled to the mount 206 without significantly interfering with the wireless charging ability of the wireless charging pad 228. Tabs 218 formed as part of the protrusion 212 act as alignment and anti-rotation features when received within cut-outs in the device case (e.g., cut-outs 116 of FIG. 1B).

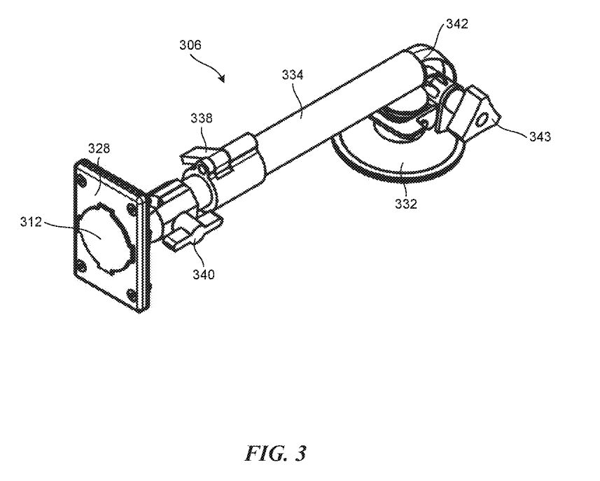

In the embodiment shown in FIGS. 1A and 2A, the mounts 106 and 206 are desk mounting apparatuses configured to be used on a flat and stationary surface. In other embodiments, however, the mount may be a car mount configured to securely hold and align a device for a user when the user is operating a vehicle. FIG. 3 shows an isometric view of a mount 306 having a wireless charging pad 328 coupled to an adjustable support arm 334. The mount 306 includes an attachment apparatus, such as suction cup 332, that securely couples the mount 306 to a surface of the car (e.g., the inside of the windshield, the dashboard, etc.), ensuring that the mount 306 does not move during operation of the car. The support arm 334 may be an adjustable support arm having a latch 338 that enables a user to adjust the length of the support arm 334 and a knob 340 may be used to adjust the angle of the wireless charging pad 328 to improve the visibility of the received device. The support arm 334 is coupled to the suction cup 332 with an adjustable hinge 342 and a knob 343 coupled to the adjustable hinge 342 is used to secure the support arm 334 and hinge at a desired angle. The wireless charging pad 328 can be coupled to a power source (e.g., the cigarette lighter receptacle in the vehicle) to enable wireless charging between the mount 306 and a coupled device. The mount 306 may also include a plurality of mount magnets adjacent to the protrusion 312 and configured to be magnetically coupled to the case magnets (e.g., case magnets 120a-d) in the case 104 (FIG. 1B).

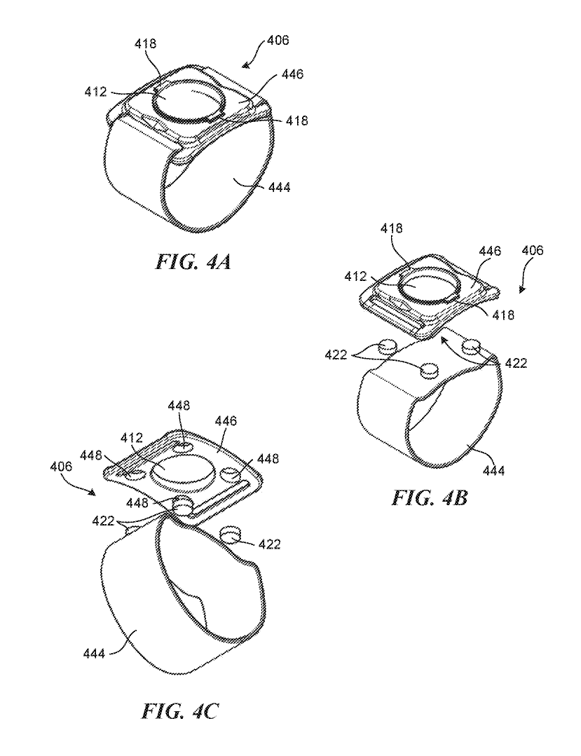

In other embodiments, the mount may be an arm-strap mounting apparatus configured to be removably coupled to a user's arm. FIGS. 4A-4C show a mount 406 having an arm strap portion 444 and a receiving plate portion 446. The receiving plate portion 446 includes a protrusion 412 configured to be received in a recess on a PED case (e.g., case 104 of FIGS. 1A and 1B), and tabs 418 on the protrusion 412 are configured to be received within cut-outs 116 in the recess 114 (FIG. 1B). The mount 406 also includes a plurality of mount magnets 422 disposed within holes 448 in the mounting plate 446 and configured to be magnetically coupled to case magnets in the case when the mount 406 receives the case. The arm mounting apparatus enables a user to have quick access to a device coupled to the mount 406 without having to use a hand to hold the device while ensuring that the device remains securely coupled to the mount 406. While this embodiment is described with a strap that can be worn on an arm of the user, the strap can be configured to be worn on other portions of the user's body or for use with other support structures to which the strap can be attached.

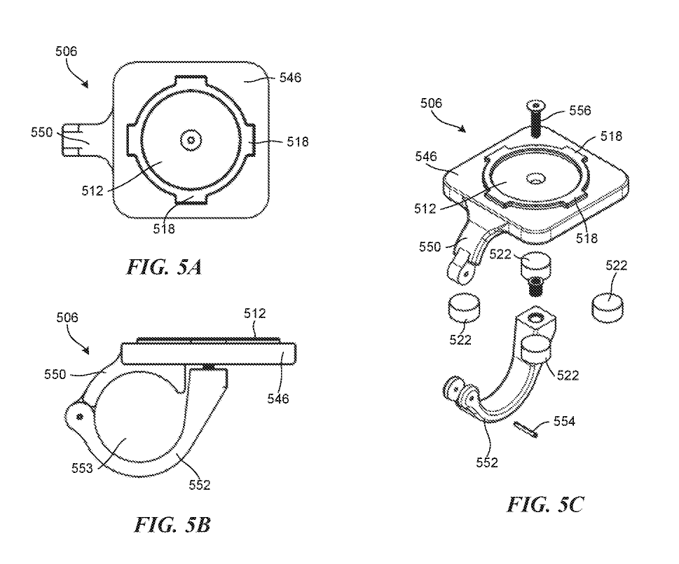

In other embodiments, the mount may be a handlebar mounting apparatus configured to attach to the handlebars of, as an example, a bicycle, motorcycle, scooter, etc. FIGS. 5A-5C show a mount 506 formed from a receiving plate 546 and a bracket that includes an upper bracket portion 550 coupled to the receiving plate 546 and a lower bracket portion 552 releasably coupled to the upper bracket portion 550 and the receiving plate 546. The upper and lower bracket portions 550 and 552 define a handlebar opening 553 configured to receive the handlebars of a bicycle or similar bar-type support structure. To ensure that the mount 506 remains securely attached to the handlebars, the receiving plate 546 and the upper bracket portion 550 are securely coupled to the lower bracket portion 552 with a hinge shaft 554 coupled between the upper and lower bracket portions 550 and 552. A screw 556 or other fastener passes through an opening in the receiving plate 546 and is removably received within a fastener hole in the lower bracket portion 552. The receiving plate 546 also includes a protrusion 512 having tabs 518 and a plurality of mount magnets 522, all of which act as alignment and/or anti-rotation features configured to securely couple the mount 506 to a device case 104 (FIG. 1B).

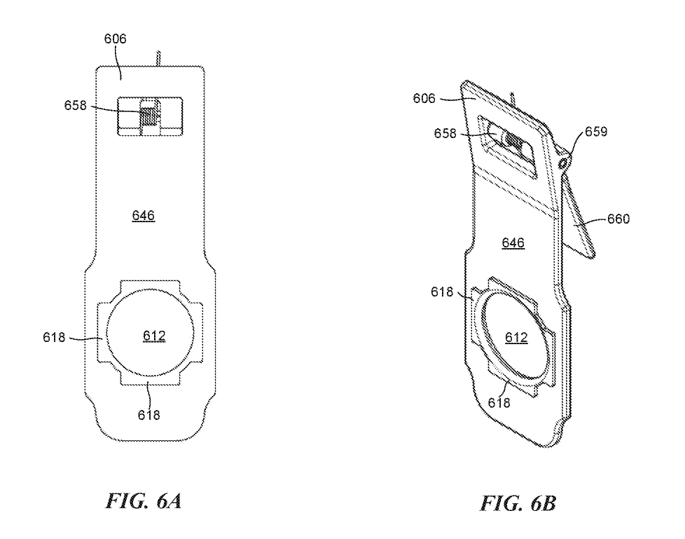

In an alternative embodiment, the mount may be a clip apparatus configured to be fastened, for example, to a user's belt or other analogous support structure. FIGS. 6A and 6B show a mount 606 having a clip portion 660 rotatably coupled to a receiving plate 646 with a hinge 659. A spring 658, which is coupled between the clip portion 660 and a rear surface of the receiving plate 646 and positioned adjacent to the hinge 659, applies a restoring force on the clip portion 660 to rotate the clip portion 660 about the hinge 659 towards the rear surface of the receiving plate 646. The force applied by the spring 658 on the clip portion 660 securely fastens the mount 606 to a support structure, such as a user's belt, waistband, pocket, purse, bag, or other similar type of mounting structure when the support structure is positioned between the clip portion 660 and the back surface of the receiving plate 646. The mount 606 also includes a protrusion 612 having tabs 618 formed at an opposite end of the mount 606 from the clip portion 660, where the protrusion 612 and tabs 618 act as alignment and/or anti-rotation features configured to securely couple the mount 606 to a device case 104 (FIG. 1B). In the illustrated embodiment, the central portion of the protrusion 612 is hollow, which results in a lighter weight unit requiring less material during manufacture.

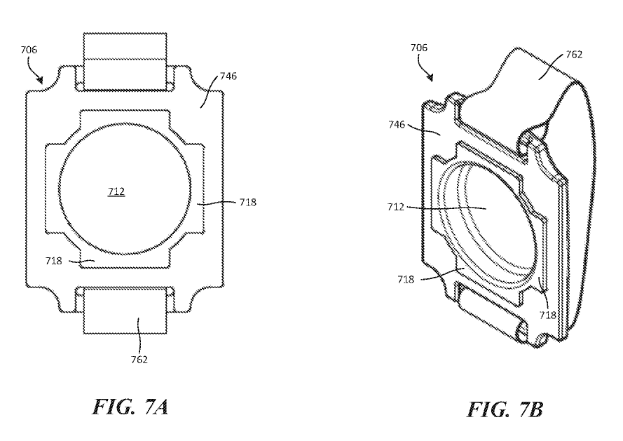

In still other embodiments, the mount may be a hand strap apparatus configured to be removably coupled to a user's hand. FIGS. 7A and 7B show a mount 706 having a receiving plate 746 coupled to a hand strap portion 762. The hand strap portion 762 is formed from a flexible material and is configured to securely receive a user's hand. The mount 706 also includes a protrusion 712 having tabs 718, where the protrusion 712 and tabs 718 act as alignment and/or anti-rotation features configured to securely couple the mount 706 to a device case 104 (FIG. 1B). In the illustrated embodiment, the central portion of the protrusion 712 can also be hollow. In other embodiments, however, the mount 706 includes a wireless charging pad position in and/or adjacent to the protrusion 712. Accordingly, when the device 102 and the case 104 (FIG. 1A) are releasably attached to the mount, wireless charging of the device 102 is enabled, while still allowing the device 102, the case 104, and the mount 706 with its integral charging pad, to be carried and used, such as by attaching the hand strap portion 762 to the user's hand, while the device 102 continues to charge. The mount 706 may be coupled to a power source via a power cable or other electrical line, or a portable power source (e.g., a battery) may be included in the mount 706 and used to provide power to a coupled device via the wireless charging pad in the mount 706 while maintaining the mobility of the charging device.

In the embodiments shown in FIGS. 6A-7B, the mounts 606, 706 can be manufactured of a ferrous-based material, such that mount magnets may not be needed around the protrusions 612, 712 (e.g., case magnets 120 of FIG. 1B). In other embodiments, however, the mounts 606, 706 do include mount magnets spaced around the protrusions 612, 712 and configured to magnetically couple to case magnets in a device case when the mounts 606, 706 are coupled to the device case 104 (FIG. 1B).

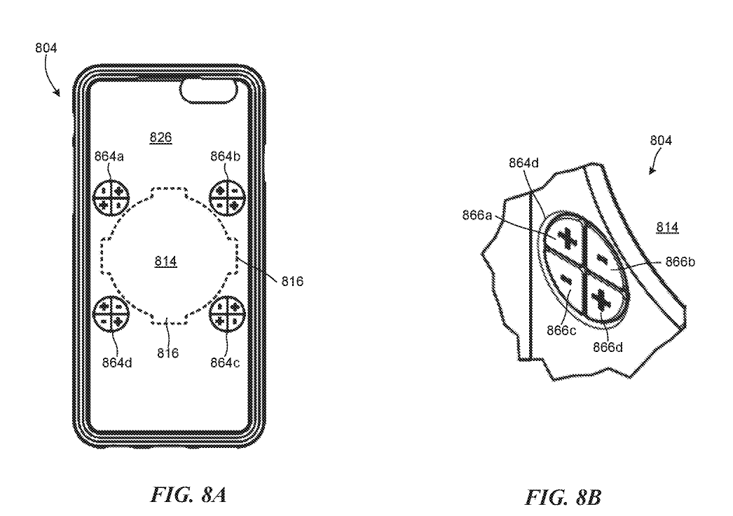

In the embodiments shown in FIGS. 1A and 1B, the case 104 and the mount 106 include disk-shaped permanent magnets having a single north pole and a single south pole. In other embodiments, however, the case and mount include multiple arrays of magnets. FIG. 8A shows a front elevation view of a case 804 having four arrays 864a-d of case magnets 866 and FIG. 8B shows an enlarged isometric view of one of the arrays 864d. The arrays 864a-d are disposed in an inner surface 826 of the case 804 and are symmetrically arranged around a central point in a recess 814, which extends through the case 804.

In the illustrated embodiment, each of the four case magnets 866 in a given array 864 is a wedge-shaped permanent magnet having a single north pole and single south pole, where two of the case magnets 866 in a given array have north poles facing a first direction while the other two case magnets 866 have north poles facing an opposite direction. The four case magnets 866 within a given array 864 are arranged into a circular arrangement such that the array 864 is disk-shaped. In the array 864d shown in FIG. 8B, the north poles of the first and fourth case magnets 866a and 866d face the device received within the case 804 (e.g., device 102 shown in FIG. 1A) while the north poles of the second and third case magnets 866b and 866c face away from the device.

The case 804 is configured to be securely coupled to a mount having a protrusion and mount magnets, where the recess 814 is configured to receive the protrusion and the case magnets 866 are configured to magnetically couple to the mount magnets. In order to maximize the strength of magnetic coupling between the mount magnets and the case magnets 866, the mount magnets may be wedge-shaped permanent magnets arranged in a circular arrangement to form disk-shaped arrays. The arrays of mount magnets are symmetrically positioned around a central point on the protrusion such that, when the case 804 is coupled to the mount, each of the case magnets 866 is positioned directly over one of the mount magnets. The mount magnets may be oriented such that each of the case magnets 866 is magnetically attracted to the mount magnet over which the case magnet 866 is arranged. For example, when the case 804 is coupled to the mount, the wedge-shaped mount magnets positioned directly below the first and fourth case magnets 866a and 866d have south poles facing the mount (and north poles facing away from the mount) while the mount magnets positioned directly below the first and fourth case magnets 866a and 866d have north poles facing the case 804 (and south poles facing away from the case 804). Similarly, the second and third case magnets 866b and 866c have north poles facing the mount (and south poles facing away from the mount) while the mount magnets positioned directly below the second and third case magnets 866b and 866c have south poles facing the case 804 (and north poles facing away from the case 804). In this way, each of the case magnets 866 are magnetically attracted to the corresponding mount magnets positioned below the case magnets 866.

The arrays 864 of case magnets 866 are rotationally symmetric about a center point in the recess 814. For example, each of the case magnets 866 within a given one of the arrays 864 has a given position and orientation when the case 804 is in a first orientation (e.g., a portrait orientation). Rotating the case 804 by 90° about a center point in the recess 814 causes the case 804 to transition from the first orientation to a second orientation (e.g., a landscape orientation). In the second orientation, each of the case magnets 866 within the given one of the arrays 864 is in the same position and has the same orientation as a case magnet 866 in a different one of the arrays 864 when the case 804 was in the first orientation. This arrangement enables the case 804 to be couplable to the mount in four different configurations.

For example, if the user desires for the device to operate in portrait mode, the user may couple the case 804 to the mount such that a top edge of the case 804 faces upwards. In this orientation, each of the case magnets 866 having south poles facing the mount (e.g., case magnets 866a and 866d) are arranged over a mount magnet having a south pole facing the case 804 and each of the case magnets 866 having north poles facing the mount (e.g., case magnets 866b and 866d) are arranged over a mount magnet having a south pole facing the case 804. However, if the user desires for the device to operate in landscape mode, the user may couple the case 804 to the mount such that the top edge of the case 804 is facing to the right. In this configuration, each of the case magnets 866 having south poles facing the mount will still be positioned over a mount magnet having a north pole facing the case 804 and each of the case magnets 866 having north poles facing the mount will be still be positioned over a mount magnet having a south pole facing the case 804. In this way, each of the case magnets 866 is magnetically attracted to the corresponding mount magnet over which the case magnet 866 is positioned regardless of the orientation in which the case 804 is coupled to the mount.

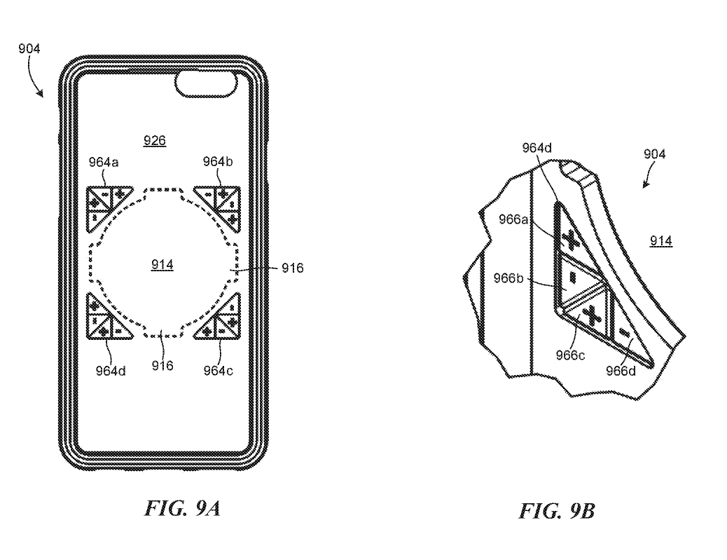

In other embodiments, the device case includes case magnets arranged in triangle-shaped arrays. FIGS. 9A and 9B show views of an alternative embodiment of a personal electronic device case having multiple arrays of magnets. FIG. 9A shows a front elevation view of a case 904 having four arrays 964a-d of case magnets 966 and FIG. 9B shows an enlarged isometric view of one of the arrays 964d. The arrays 964a-d are disposed in an inner surface 926 of the case 904 and are symmetrically arranged around a central point in a recess 914, which extends through the case 904. In this embodiment, each of the four case magnets 966 is a triangle-shaped permanent magnet having a single north pole and a single south pole. In each array 964, the two case magnets 966 have north poles facing a first direction while the other two case magnets 966 have north poles facing an opposite direction. The four case magnets 966 within a given array 964 are arranged into a triangular arrangement such that the array 964 is also triangle-shaped. In the array 964d shown in FIG. 9B, the north poles of the first and fourth case magnets 966a and the 966d face the device received within the case 904 (e.g., device 102 shown in FIG. 1A) while the north poles of the second and third case magnets 966b and 966d face away from the device.

As in the embodiments described above in connection with FIGS. 8A and 8B, the case 904 is configured to be securely coupled to a mount having mount magnets, where the recess 914 is configured to receive the protrusion and the case magnets 966 are configured to magnetically couple to the mount magnets. The mount magnets may be triangle-shaped permanent magnets arranged into a triangular arrangement to form triangle-shaped arrays and symmetrically positioned around a central point on the protrusion such that, when the case 904 is coupled to the mount, each of the case magnets 966 is positioned directly over one of the mount magnets. The mount magnets may be oriented such that each of the case magnets 966 is magnetically attracted to the corresponding mount magnet over which the case magnets 966 is arranged. In this way, the arrays 964 of case magnets 966 are rotationally symmetric about a center point in the recess 914 such that the case 904 is couplable to the mount in four different orientations, where each of the case magnets 966 is magnetically attracted to the corresponding mount magnet over which the case magnet 966 is positioned regardless of the orientation in which the case 904 is coupled to the mount.

In the embodiments shown in FIGS. 8A-9B, the arrays of case magnets (and the corresponding arrays of mount magnets) include magnets having north poles facing either a first direction or an opposing second direction opposite the first direction. In other embodiments, however, the arrays of magnets also include magnets having north poles facing a third direction perpendicular to the first and second directions and a fourth direction opposite the third direction such that the magnets form a shape similar to a Halbach array. When an array of magnets is arranged in a Halbach array, the strength of a magnetic field from the array is greater in a first direction than in an opposing direction. As a result, the strength of the magnetic field for the arrays 864, 964 of case magnets 866, 966 may be stronger in the direction facing away from a received device than in the direction facing the received device. Similarly, the strength of the magnetic field for the arrays of mount magnets may be stronger in the direction facing the cases 804, 904 than in the direction facing away from the cases 804, 904. This arrangement can increase the effective strength of the magnetic coupling between the case and the mount while limiting any potential magnetic interference between the case magnets 866, 966 and the received device.

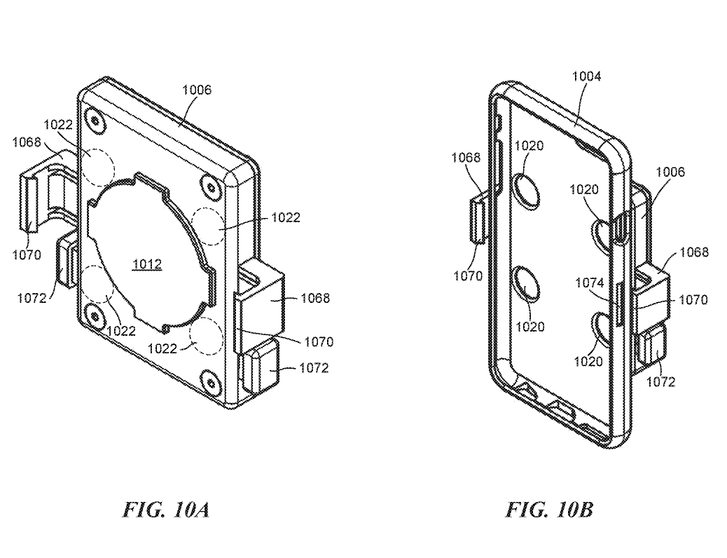

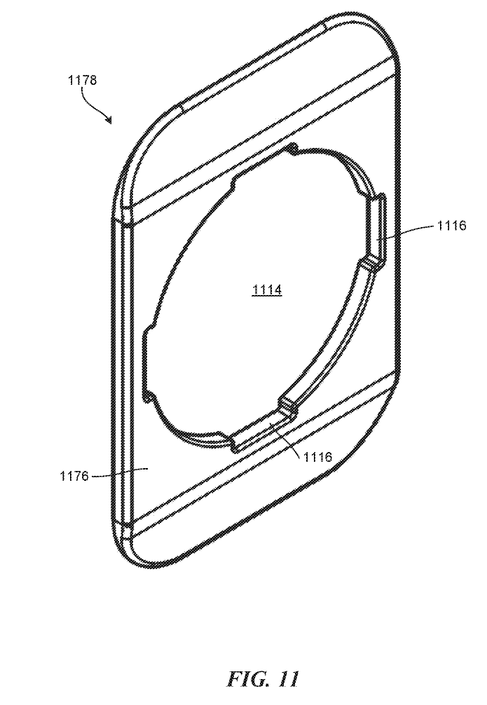

In some embodiments, the mount may also include a clamping mechanism that functions as an additional alignment and anti-rotation feature. FIG. 10A is an isometric view of a mount 1006 having a clamping mechanism and FIG. 10B is an isometric view of a case 1004 received within the mount 1006. The mount 1006 includes a protrusion 1012 configured to be received within a recess in the case 1004 and mount magnets 1022 configured to magnetically couple to case magnets 1020 on the case 1004. The mount 1006 also includes clamps 1068 having ends 1070 configured to be received in openings 1074 formed along the edges of the case 1004 and grips 1072 operatively coupled to the clamps 1068 and configured to be used to adjust the position of the ends 1070 of the clamps 1068. When coupling the case 1004 to the mount 1006, a user may use the grips 1072 to adjust the position of the clamps 1068 to ensure that the ends 1070 are securely positioned within the openings 1074. In this way, the clamps 1070 act as an additional alignment and anti-rotation feature that prevents the case 1004 from pulling away from the mount 1006. The clamp also resists rotation of the case 1004 relative to the mount 1006.

In the embodiments shown in FIGS. 1A-B, 8A-B, and 9A-B, the alignment and anti-rotation features (e.g., the recess 114, cut-outs 116, and case magnets 120) are formed as part of a case configured to receive a PED. In other embodiments, however, the alignment and anti-rotation features may be formed as part of an interface plate configured to be attached to the rear surface of a personal electronic device or to the rear surface of a case in which the personal electronic device is already received. FIG. 11 is an isometric view of an interface plate 1176 having a recess 1114 that includes cut-outs 1116 and configured to receive a protrusion having tabs formed as part of a mount (e.g., protrusion 112 having tabs 118 on mount 106 of FIG. 1A) when the interface plate 1176 is coupled to the mount.

The recess 1114 is sized and shaped such that, when the interface plate 1176 is properly coupled to the device (or case), the recess 1114 is positioned directly over wireless charging circuitry within the device and does not inhibit the wireless charging capabilities of the device when the device is coupled to a mount having a wireless charging capabilities (e.g., mount 206 of FIG. 2A or mount 306 of FIG. 3). An adhesive or other attachment mechanism can be applied to a rear surface 1178 of the interface plate 1176 is configured to adhere the interface plate 1176 to the rear surface of the device or device case. Attaching the interface plate 1176 to a device (or a case) enables a user to securely couple the device to a mount (e.g., mount 106 of FIG. 1A) without having to utilize a case specifically configured to be coupled to the mount.

In the embodiment shown in FIG. 11, the interface plate 1176 includes a generally circular recess 1114 having tabs and embedded case magnets (e.g., case magnets 120). In other embodiments, however, the interface plate may include a recess having a different shape and may include case magnets configured to magnetically couple to mount magnets on a mount. For example, FIG. 12A shows an interface plate 1276a having a generally circular recess 1214a and circular case magnets 1220a distributed around the recess 1214a. On the other hand, FIG. 12B shows an interface plate 1276b having a generally circular recess 1214b and generally triangular case magnets 1220b distributed around the recess 1214b. The triangular case magnets 1220b have a curved edge that conforms to the curvature of the recess 1214b. As discussed above in connection with FIGS. 1A and 1B, using generally triangular case magnets allows for a larger recess 1214b while the size of the case magnets is unchanged or increased. This further ensures that the wireless charging capabilities of the device are not inhibited.

FIG. 12C shows an interface plate 1276c having a recess 1214c formed from a 24-sided polygon in the shape of a star having 12 points. The interface plate 1276c may also include four case magnets 1220c distributed around the recess 1214c. The shape of the recess 1214c enables the interface plate 1276c to be coupled a mount having a similarly-shaped protrusion in 12 different orientations with some magnetic retention due to the proximity of the magnets in each position. The strongest magnetic coupling between the case magnets 1220c and mount magnets on the mount, however, will occur when the interface plate 1276c is oriented in four of the orientations with direct magnetic alignment.

FIG. 12D shows an interface plate 1276d having a recess 1214d and case magnets 1220d. The recess 1214d is generally circular shaped but has notches adjacent to each of the case magnets 1220d to accommodate the case magnets 1220d. This increases the size of the recess 1214d, thereby ensuring that the wireless charging capabilities of the device are not inhibited by the interface plate 1276d.

From the foregoing, it will be appreciated that specific embodiments of the invention have been described herein for purposes of illustration, but that various modifications may be made without deviating from the scope of the invention. Accordingly, the invention is not limited except as by the appended claims.

I/We claim:

1. A mounting assembly for a personal electronic device, comprising:
a case having a back wall and sidewalls connected to the backwall to define an interior area configured to receive the personal electronic device, the back wall having:
opposing front and rear surfaces, the front surface facing toward the interior area and being configured to be positioned adjacent to the personal electronic device when the personal electronic device is received within the interior area;
a recess in the rear surface, the recess having a central portion and a plurality of registration recesses spaced radially apart from each other; and
a case magnet positioned adjacent to the recess and spaced apart from the central portion; and
a mounting structure releasably engageable with the case at a selected radial orientation, the mounting structure comprising:
a receiving surface configured to be positioned adjacent to rear surface when the case is engaged with the mounting structure;
a protrusion extending away from the receiving surface and configured to be securely received in the recess when the case is coupled to the mounting structure, the protrusion having a central protuberance that fits closely in the central portion of the recess, and one or more radial registration protuberances is positioned to fit in selected ones of the registration recesses to control a selected radial orientation of the case relative to the mounting structure; and
a mount magnet positioned adjacent to the protrusion and arranged to align with the case magnet when the case is coupled to the mounting structure in the selected radial orientation, wherein the case is mechanically and magnetically restricted from rotating when the case is engaged with the mounting structure.

2. The mounting assembly of claim 1 wherein the mounting structure has a retention portion configured to releasably mount to a vehicle, a handlebar, or a wearable strap.

3. The mounting assembly of claim 1 wherein the mounting structure comprises a clamping member configured to releasably attach to a mounting support.

4. The mounting assembly of claim 1 wherein the case magnet is a first case magnet and the mount magnet is a first mount magnet, the mounting assembly further comprising:
a second case magnet positioned adjacent to the recess and spaced radially apart from the first case magnet; and
a second mount magnet positioned adjacent to the protrusion and spaced radially apart from the first mount magnet, wherein, when the case is coupled to the mounting structure in the selected radial orientation, the second case magnet is positioned over and magnetically coupled to the second mount magnet.

5. The mounting assembly of claim 1 wherein the selected orientation is a first orientation, and the case being positionable in a second radial orientation relative to the mounting structure, and the second orientation is different from the first orientation;
the case magnet is a first case magnet, and the case has a second case magnet spaced radially apart from the first case magnet; and
when the case is coupled to the mounting structure in the first radial orientation, the first case magnet is positioned over and magnetically coupled to the mount magnet, and
when the case is coupled to the mounting structure in the second radial orientation, the second case magnet is positioned over and magnetically coupled to the mount magnet.

6. The mounting assembly of claim 1 wherein—
the selected orientation is a first orientation, and the case being positionable in a second radial orientation relative to the mounting structure, and the second orientation is different from the first orientation; the mount magnet is a first mount magnet, and the mounting structure has a second mount magnet spaced radially apart from the first mount magnet; and
when the case is coupled to the mounting structure in the first radial orientation, the first case magnet is positioned over and magnetically coupled to the first mount magnet, and
when the case is coupled to the mounting structure in the second radial orientation, the first case magnet is positioned over and magnetically coupled to the second mount magnet.

7. The mounting assembly of claim 1, wherein the selected radial orientation is a first radial orientation, and the case being positioned relative to the mounting structure in a second radial orientation, a third radial orientation or a fourth radial orientation when the case is engaged with the mounting structure with the protrusion in the recess; and
wherein the case magnet is a first case magnet, and the case having second, third and fourth case magnets arranged radially apart from each other, and wherein the registration recess is a first registration recess and the plurality of registration recesses comprises second, third and fourth registration recesses,
when the case is coupled to the mounting structure in the first orientation, the first case magnet is positioned over and magnetically coupled to the mount magnet and the registration protuberance is positioned in the first registration recess,
when the case is coupled to the mounting structure in the second orientation, the second case magnet is positioned over and magnetically coupled to the mount magnet and the registration protuberance is positioned in the second registration recess,
when the case is coupled to the mounting structure in the third orientation, the third case magnet is positioned over and magnetically coupled to the mount magnet and the registration protuberance is positioned in the third registration recess, and
when the case is coupled to the mounting structure in the fourth orientation, the fourth case magnet is positioned over and magnetically coupled to the mount magnet and the registration protuberance is positioned in the fourth registration recess.

8. The mounting assembly of claim 7 wherein the first, second, third, and fourth case magnets are symmetrically arranged around a central point of the recess and wherein the first, second, third, and fourth registration recesses are symmetrically arranged around the central portion of the recess.

9. The mounting assembly of claim 1, wherein the selected radial orientation is a first radial orientation, and the case being positioned relative to the mounting structure in a second radial orientation, a third radial orientation or a fourth radial orientation when the case is engaged with the mounting structure with the protrusion in the recess; and
wherein the mount magnet is a first mount magnet, and the mounting structure having second, third and fourth mount magnets arranged radially apart from each other, and wherein the registration protuberance is a first registration protuberance and the mounting structure has second, third and fourth registration protuberance spaced radially apart from each other,
when the case is coupled to the mounting structure in the first orientation, the case magnet is positioned over and magnetically coupled to the first mount magnet and the first registration protuberance is positioned in the registration recess,
when the case is coupled to the mounting structure in the second orientation, the case magnet is positioned over and magnetically coupled to the second mount magnet and the second registration protuberance is positioned in the registration recess,
when the case is coupled to the mounting structure in the third orientation, the case magnet is positioned over and magnetically coupled to the third mount magnet and the third registration protuberance is positioned in the registration recess, and
when the case is coupled to the mounting structure in the fourth orientation, the case magnet is positioned over and magnetically coupled to the fourth mount magnet and the fourth registration protuberance is positioned in the registration recess.

10. The mounting assembly of claim 9 wherein the first, second, third, and fourth mount magnets are symmetrically arranged around the central protuberance and wherein the first, second, third, and fourth registration protuberances are symmetrically arranged around the central protuberance.

11. The mounting assembly of claim 9 wherein each of the first, second, third, and fourth radial orientations are approximately 90 degrees from two of the radial orientations and approximately 180 degrees from the other radial orientation.

12. The mounting assembly of claim 1 wherein—
the central protuberance of the protrusion comprises a generally circular central protuberance and the radial registration protuberance is an anti-rotation tab extending radially away from a central protuberance, and
the central portion of the recess comprises a generally circular recess connected to the plurality of registration recesses positioned to receive the at least one anti-rotation tab such that, when the case is coupled to the mounting structure, the at least one anti-rotation tab is positioned within a selected one of the registration recesses.

13. The mounting assembly of claim 1, the personal electronic device includes a wireless charging receiver, and wherein the central portion of the recess is shaped and sized to align with the wireless charging receiver when the personal electronic device is received within the case, and wherein the case magnet is positioned to be spaced radially away from the wireless charging receiver.

14. The mounting assembly of claim 13 wherein the mounting structure further comprises:
a wireless charging pad coupled to the receiving surface, wherein the wireless charging pad is configured to provide a current received from a power source to the protrusion and wherein the protrusion functions as a wireless charging transmitter that transmits the received current to the wireless charging receiver in the personal electronic device to wirelessly charge the personal electronic device.

15. A mounting assembly for a personal electronic device, comprising:
a case configured to securely receive the personal electronic device, the case having:
a recess formed in a rear surface of the case;
a first plurality of case magnets arranged to form a first array positioned adjacent to the recess such that each of the first plurality of case magnets does not overlap with the recess; and
a second plurality of case magnets arranged to form a second array positioned adjacent to the recess such that each of the second plurality of case magnets does not overlap with the recess; and
a mounting structure releasably couplable to the case with the case in a selected orientation, wherein the mounting structure is configured to securely hold the case at the selected orientation, the mounting structure has:
a protrusion extending away from a receiving surface and configured to be securely received in the recess when the case is coupled to the mounting structure;
a first plurality of mount magnets arranged to form a third array positioned adjacent to the protrusion such that each of the first plurality of mount magnets does not overlap with the protrusion; and
a second plurality of mount magnets arranged to form a fourth array positioned adjacent to the protrusion such that each of the second plurality of mount magnets does not overlap with the protrusion and wherein, when the case is coupled to the mounting structure in the selected orientation, individual ones of the first plurality of case magnets are positioned over and magnetically coupled to individual of the first plurality of mount magnets and individual ones of the second plurality of case magnets are positioned over and magnetically coupled to individual of the second plurality of mount magnets.

16. The mounting assembly of claim 15, wherein—
the first plurality of mount magnets comprises a first mount magnet having a first north pole and a second mount magnet having a second north pole,
the first and second mount magnets are coupled to the mounting structure such that the first north pole faces in a first direction and the second north pole faces in a second direction opposite the first direction,
the first plurality of case magnets comprises a first case magnet having a third north pole and a second case magnet having a fourth north pole, and
when the case is coupled to the mounting structure, the first case magnet is positioned over the first mount magnet, the second case magnet is positioned over the second mount magnet, the third north pole faces in the first direction such that the first case magnet is magnetically coupled to the first mount magnet, and the fourth north pole faces in the second direction such that the second case magnet is magnetically coupled to the second mount magnet.

17. The mounting assembly of claim 16, wherein—
the first plurality of mount magnets comprises a third mount magnet having a fifth north pole and a fourth mount magnet having a sixth north pole,
the first and second mount magnets are coupled to the mounting structure such that the fifth north pole faces in the first direction and the sixth north pole faces in the second direction,
the first plurality of case magnets comprises a third case magnet having a seventh north pole and a fourth mount magnet having an eighth north pole, and
when the case is coupled to the mounting structure, the third case magnet is positioned over the third mount magnet, the fourth case magnet is positioned over the fourth mount magnet, the seventh north pole faces in the first direction such that the third case magnet is magnetically coupled to the third mount magnet, and the eighth north poles faces in the second direction such that the fourth case magnet is magnetically coupled to the fourth mount magnet.

18. The mounting assembly of claim 15 wherein—
the selected orientation comprises a first orientation,
the case is releasably couplable to the mounting structure in a second orientation different from the first orientation,
when the case is coupled to the mounting structure in the second orientation, individual of the first plurality of case magnets are positioned over and magnetically coupled to individual of the second plurality of mount magnets and individual of the second plurality of case magnets are positioned over and magnetically coupled to individual of the first plurality of mount magnets.

19. A mounting assembly for a personal electronic device, comprising:
a case having an interior area configured to receive the personal electronic device, the case having a recess formed therein with a central portion and a plurality of registration recesses spaced apart from each other; and
a case magnet positioned adjacent to the recess and spaced apart from the central portion; and
a mounting structure releasably engageable with the case at a selected orientation, the mounting structure comprising:
a protrusion configured to be securely received in the recess when the case is engaged with the mounting structure, the protrusion having a central protuberance that fits closely in the central portion of the recess, and one or more registration protuberances adjacent to the central protuberance and positioned to fit in selected ones of the registration recesses to control a selected orientation of the case relative to the mounting structure; and
a mount magnet positioned adjacent to the protrusion and arranged to align with the case magnet when the case is engaged with the mounting structure in the selected orientation, wherein the case is mechanically and magnetically restricted from rotating when the case is engaged with the mounting structure.

20. A mounting assembly of claim 19, wherein the number of registration recesses equals the number of registration protuberances.
